(19) United States
(12) Patent Application Publication
(10) Pub. No.: US 2026/0355634 A1
(43) Pub. Date: Nov. 12, 2026

(54) ONE OR MORE NON-TRANSITORY COMPUTER-READABLE STORAGE MEDIA, GAME SYSTEM, GAME APPARATUS, AND COMPUTER-IMPLEMENTED METHOD

(71) Applicant: Nintendo Co., Ltd., Kyoto-shi (JP)

(72) Inventors: Naonori OHNISHI, Kyoto (JP); Ryosuke KAKUTANI, Kyoto (JP)

(21) Appl. No.: 19/648,994

(22) Filed: Apr. 15, 2026

(30) Foreign Application Priority Data
May 12, 2025 (JP) 2025-080028

(51) Int. Cl. A63F 13/63; A63F 13/52

(52) U.S. Cl. CPC A63F 13/63; A63F 13/52

(57) ABSTRACT

In a first scene, an appearance parameter for each of a plurality of types of character parts of a character is changed, and a display or non-display state is set. In addition, an additional part different from the character parts and generated by a user is placed. Moreover, in a second scene in which a third game character is generated based on first and second game characters, if a certain type of character part is displayed in the first game character, one of the character parts of the first and second game characters is set for the third game character, and if the certain type of character part is in the non-display state in the first game character, the certain type of character part is also set to the non-display state in the third game character, and an additional part in the first game character is further placed therein.

### CROSS REFERENCE TO RELATED APPLICATION

This application claims priority to Japanese Patent Application No. 2025-080028 filed on May 12, 2025, the entire contents of which are incorporated herein by reference.

### FIELD

The present disclosure relates to game processing in which a character can be generated by placing parts.

### BACKGROUND AND SUMMARY

Conventionally, games in which a character object is generated by combining multiple part objects are known.

In games of this type, there has been room for improvement in the generation of a character object.

In view of the above circumstances, for example, the following configuration examples are provided.

### Configuration Example 1

Configuration Example 1 is directed to one or more non-transitory computer-readable storage media having stored therein instructions for causing one or more processors to execute a game in which a game character having a plurality of types of character parts placed in a part placement area thereof is displayed, the instructions, when executed, causing the one or more processors to perform processing including:
in a first scene in which an appearance of the game character in the game is set, in response to a character part editing instruction based on an operation input, changing an appearance parameter indicating an appearance in the game of each of the plurality of types of character parts of the game character,
in response to a display state editing instruction based on an operation input, setting each of the plurality of types of character parts of the game character to a display state in which the part is displayed in the game or a non-display state in which the part is hidden, and
in response to an additional part placement instruction based on an operation input, placing an additional part in the part placement area of the game character, the additional part being different from the plurality of types of character parts and generated in response to a part generation instruction performed by a user; and
in a second scene in which a third game character is generated based on a first game character and a second game character in the game,
   if a first type of character part among the plurality of types of character parts of the first game character is set to the display state, setting the appearance parameter of the first type of character part of the third game character in accordance with the appearance parameter of the first type of character part of at least one of the first game character and the second game character,
   if the first type of character part among the plurality of types of character parts of the first game character is set to the non-display state, setting the first type of character part of the third game character to the non-display state, and
   further placing an additional part based on the additional part placed in the part placement area of the first game character, in the part placement area of the third game character.

According to the above configuration example, it is possible to generate a third character in which parts corresponding to the character parts used in the first and second characters are placed.

### Configuration Example 2

In Configuration Example 2 based on Configuration Example 1 above, the processing may further include, in the first scene, generating the additional part in response to an additional part generation instruction based on an operation input.

### Configuration Example 3

In Configuration Example 3 based on Configuration Example 2 above, in response to the additional part generation instruction, at least one of a pattern, a shape, a color, and a size of the additional part may be set.

### Configuration Example 4

In Configuration Example 4 based on Configuration Example 1 above, the processing may further include, in the second scene, not placing the additional part in the part placement area of the third game character if the additional part is not placed in the part placement area of the first game character.

### Configuration Example 5

In Configuration Example 5 based on Configuration Example 4 above, the processing further include, in the second scene, if all of the plurality of types of character parts of the first game character are in the non-display state, the additional part is not placed therein, and the additional part is placed in the second game character,
placing an additional part based on the additional part placed in the part placement area of the second game character, in the part placement area of the third game character.

### Configuration Example 6

In Configuration Example 6 based on Configuration Example 1 above, the processing may further include, in the second scene, if the first type of character part of the first game character is in the non-display state, the additional part is not placed therein, and the first type of character part of the second game character is in the display state,
setting the appearance parameter of the first type of character part of the third game character in accordance with the appearance parameter of the first type of character part of the second game character.

### Configuration Example 7

In Configuration Example 7 based on Configuration Example 1 above, the appearance parameter may include at least a placement position parameter indicating a position at which the character part is placed with respect to the part placement area, and the processing may further include, in the second scene, if the first type of character part of the first game character is set to the display state, setting the placement position parameter of the first type of character part of the third game character in accordance with the placement position parameter of the first type of character part of the first game character.

### Configuration Example 8

In Configuration Example 8 based on Configuration Example 1 above, the processing may further include, in the first scene, in response to the additional part placement instruction, placing the additional part on a front side located in front of the character parts or on a back side located behind the character parts.

### Configuration Example 9

In Configuration Example 9 based on Configuration Example 8 above, the processing may further include, in the second scene:
if the additional part of the first game character is placed on the front side, placing the additional part of the third game character on the front side; and
if the additional part of the first game character is placed on the back side, placing the additional part of the third game character on the back side.

Each configuration example described above may be applied to a game system including at least one processor, a game apparatus including at least one processor, and a game processing method executed by a computer including at least one processor.

### BRIEF DESCRIPTION OF THE DRAWINGS

FIG. 1 shows a non-limiting example of a state in which a left controller 3 and a right controller 4 are attached to a main body apparatus 2;

FIG. 2 shows a non-limiting example of a state in which the left controller 3 and the right controller 4 are detached from the main body apparatus 2;

FIG. 3 is six orthogonal views showing a non-limiting example of the main body apparatus 2;

FIG. 4 is six orthogonal views showing a non-limiting example of the left controller 3;

FIG. 5 is six orthogonal views showing a non-limiting example of the right controller 4;

FIG. 6 is a block diagram showing a non-limiting example of the internal configuration of the main body apparatus 2;

FIG. 7 is a block diagram showing a non-limiting example of the internal configurations of the main body apparatus 2, the left controller 3, and the right controller 4;

FIG. 8 shows a non-limiting example of a game screen according to an exemplary embodiment;

FIG. 9 shows a non-limiting example of the game screen according to the exemplary embodiment;

FIG. 10 is a schematic diagram illustrating a non-limiting example of the relationship among a head object, basic parts, and an FP;

FIG. 11 shows a non-limiting example of the game screen according to the exemplary embodiment;

FIG. 12 shows a non-limiting example of the game screen according to the exemplary embodiment;

FIG. 13 is a schematic diagram illustrating a non-limiting example of the relationship among the head object, the basic parts, and the FP;

FIG. 14 illustrates a non-limiting example of a method for determining child face parts;

FIG. 15 illustrates a non-limiting example of a child’s face;

FIG. 16 illustrates another non-limiting example of the child’s face;

FIG. 17 is a memory map showing a non-limiting example of various data stored in a DRAM 85;

FIG. 18 shows a non-limiting example of the data structure of basic part master data 302;

FIG. 19 shows a non-limiting example of the data structure of virtual resident data 305;

FIG. 20 is a non-limiting example of a flowchart showing the details of face edit processing according to the exemplary embodiment;

FIG. 21 is a non-limiting example of a flowchart showing the details of basic part processing;

FIG. 22 is a non-limiting example of a flowchart showing the details of the basic part processing;

FIG. 23 is a non-limiting example of a flowchart showing the details face paint processing; and

FIG. 24 is a non-limiting example of a flowchart showing the details of child face part determination processing.

### DETAILED DESCRIPTION OF NON-LIMITING EXAMPLE EMBODIMENTS

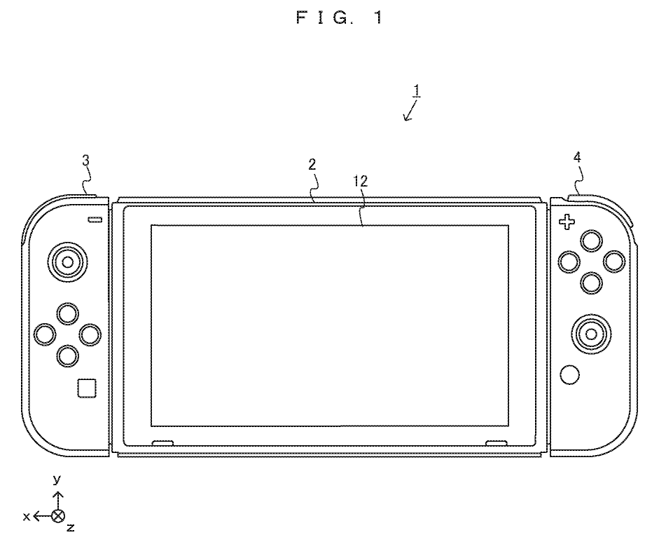

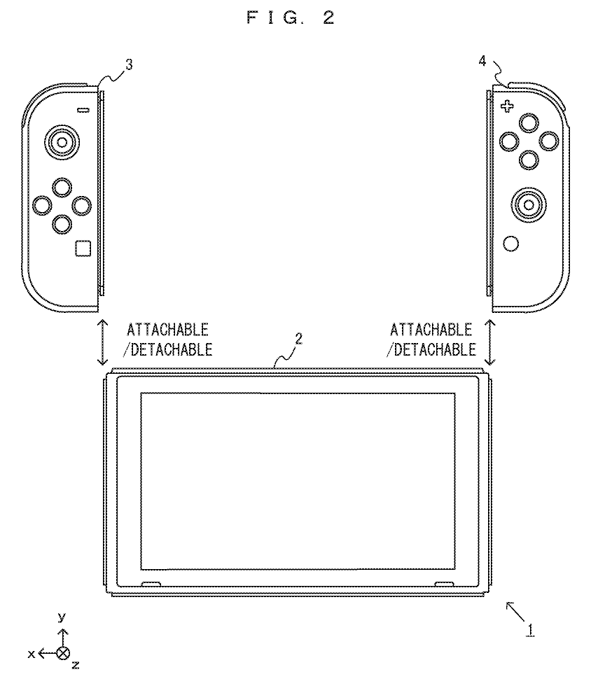

Hereinafter, an exemplary embodiment will be described. FIG. 1 shows an example of the appearance of a game system which is an example of an information processing system. An example of a game system 1 according to the exemplary embodiment includes a main body apparatus (an information processing apparatus, which functions as a game apparatus main body in the exemplary embodiment) 2 which is an example of a computer, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment will be described, and then, the control of the game system 1 according to the exemplary embodiment will be described.

FIG. 1 shows an example of the state where the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a player provides inputs.

FIG. 2 shows an example of the state where each of the left controller 3 and the right controller 4 is detached from the main body apparatus 2. As shown in FIGS. 1 and 2, the left controller 3 and the right controller 4 are attachable to and detachable from the main body apparatus 2. Hereinafter, the left controller 3 and the right controller 4 may be collectively referred to as “controller”.

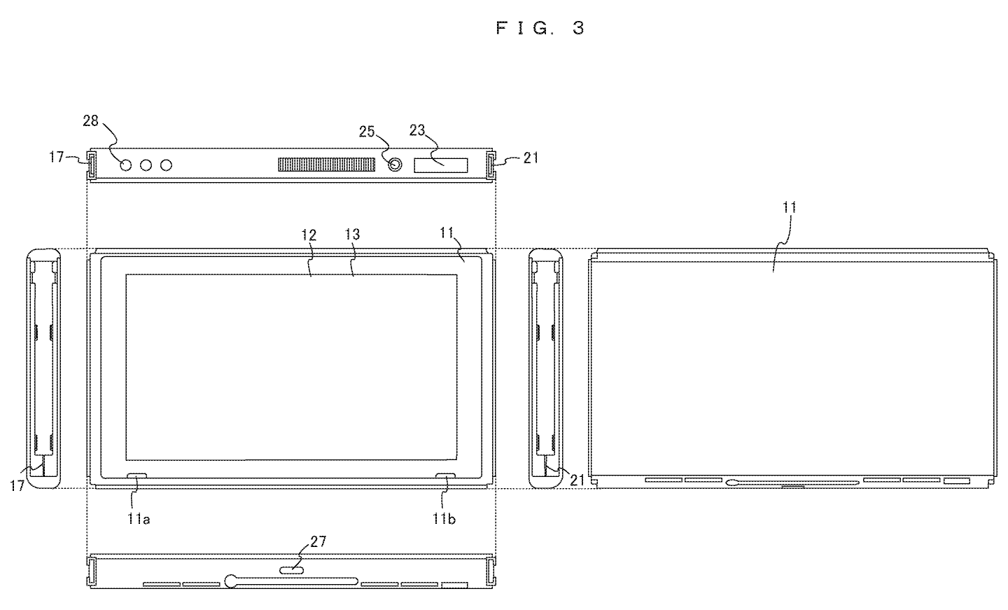

FIG. 3 is six orthogonal views showing an example of the main body apparatus 2. As shown in FIG. 3, the main body apparatus 2 includes an approximately plate-shaped housing 11. In the exemplary embodiment, a main surface (in other words, a surface on a front side, i.e., a surface on which the display 12 is provided) of the housing 11 has a substantially rectangular shape.

The shape and the size of the housing 11 are discretionary. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

The main body apparatus 2 includes a touch panel 13 on the screen of the display 12. In the exemplary embodiment, the touch panel 13 is of a type capable of receiving a multi-touch input (e.g., electrical capacitance type). However, the touch panel 13 may be of any type, and may be, for example, of a type capable of receiving a single-touch input (e.g., resistive film type).

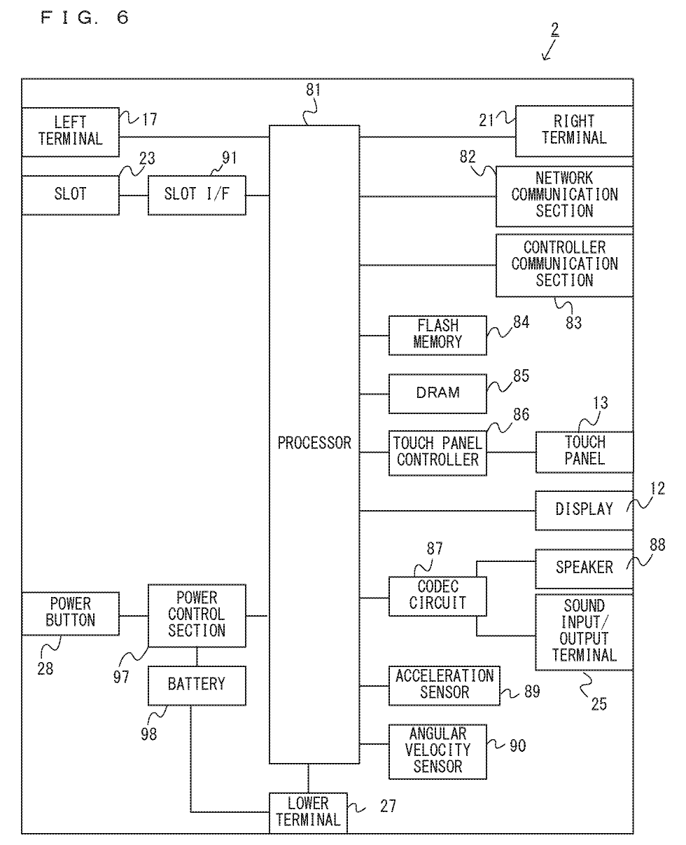

The main body apparatus 2 includes speakers (i.e., speakers 88 shown in FIG. 6) within the housing 11. As shown in FIG. 3, speaker holes 11a and 11b are formed in the main surface of the housing 11. Then, sounds outputted from the speakers 88 are outputted through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided at an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a stationary monitor an image generated by and outputted from the main body apparatus 2. Further, in the exemplary embodiment, the cradle has the function of charging the unified apparatus or the main body apparatus 2 alone mounted on the cradle. Further, the cradle has the function of a hub device (specifically, a USB hub).

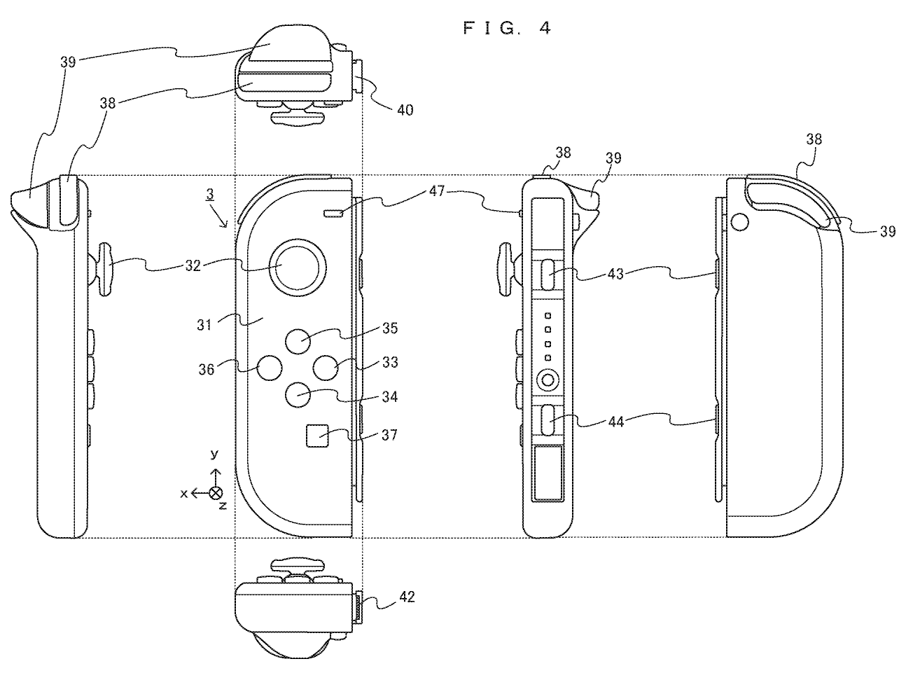

FIG. 4 is six orthogonal views showing an example of the left controller 3. As shown in FIG. 4, the left controller 3 includes a housing 31. In the exemplary embodiment, the housing 31 has a vertically long shape, i.e., is shaped to be long in an up-down direction shown in FIG. 4 (i.e., a y-axis direction shown in FIG. 4). In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly, the left hand. Further, the left controller 3 can also be held in the orientation in which the left controller 3 is horizontally long. When held in the orientation in which the left controller 3 is horizontally long, the left controller 3 may be held with both hands.

The left controller 3 includes a left analog stick (hereinafter, referred to as a “left stick”) 32 as an example of a direction input device. As shown in FIG. 4, the left stick 32 is provided on a main surface of the housing 31. The left stick 32 can be used as a direction input section with which a direction can be inputted. The player tilts the left stick 32 and thereby can input a direction corresponding to the direction of the tilt (and input a magnitude corresponding to the angle of the tilt). The left controller 3 may include a directional pad, a slide stick that allows a slide input, or the like as the direction input section, instead of the analog stick. Further, in the exemplary embodiment, it is possible to provide an input by pressing the left stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an OS program and an application program) executed by the main body apparatus 2.

Further, the left controller 3 includes a terminal 42 for the left controller 3 to perform wired communication with the main body apparatus 2.

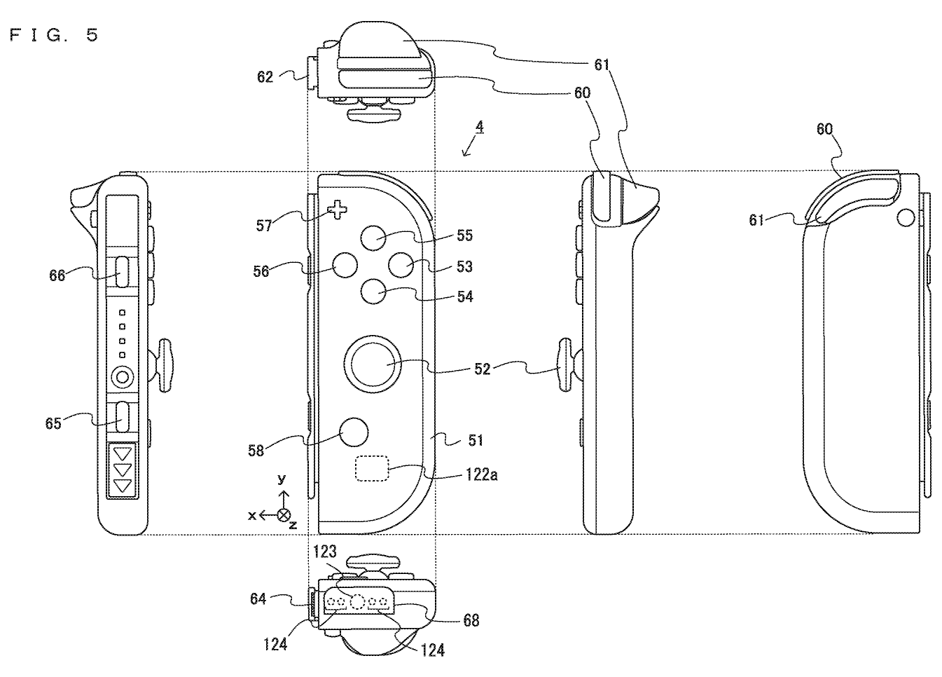

FIG. 5 is six orthogonal views showing an example of the right controller 4. As shown in FIG. 5, the right controller 4 includes a housing 51. In the exemplary embodiment, the housing 51 has a vertically long shape, i.e., is shaped to be long in the up-down direction shown in FIG. 5 (i.e., the y-axis direction shown in FIG. 5). In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller b can also be held in the orientation in which the right controller 4 is horizontally long. When held in the orientation in which the right controller 4 is horizontally long, the right controller 4 may be held with both hands.

Similarly to the left controller 3, the right controller 4 includes a right analog stick (hereinafter, referred to as a “right stick”) 52 as a direction input section. In the exemplary embodiment, the right stick 52 has the same configuration as that of the left stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 91, 97, and 98 shown in FIG. 6 in addition to the components shown in FIG. 3. Some of the components 81 to 91, 97, and 98 may be mounted as electronic components on an electronic circuit board and housed in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) stored in a storage section (specifically, an internal storage medium such as a flash memory 84, an external storage medium attached to the slot 23, or the like), thereby performing the various types of information processing.

The main body apparatus 2 includes the flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The processor 81 appropriately reads and writes data from and to the storage media such as the flash memory 84 and the DRAM 85 to execute various types of information processing. In the exemplary embodiment, the “memory” may include at least a flash memory and a DRAM and may also include other storage media.

The main body apparatus 2 includes a slot interface (hereinafter, abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined method for communication (e.g., communication based on a unique protocol or infrared light communication). The wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2, and the left controller 3 and the right controller 4, is discretionary. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of players can simultaneously provide inputs to the main body apparatus 2, each using a set of the left controller 3 and the right controller 4. As an example, a first player can provide an input to the main body apparatus 2 using a first set of the left controller 3 and the right controller 4, and simultaneously, a second player can provide an input to the main body apparatus 2 using a second set of the left controller 3 and the right controller 4.

The main body apparatus 2 includes a touch panel controller 86, which is a circuit for controlling the touch panel 13. The touch panel controller 86 is connected between the touch panel 13 and the processor 81. On the basis of a signal from the touch panel 13, the touch panel controller 86 generates data indicating the position at which a touch input has been performed, for example, and outputs the data to the processor 81.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). On the basis of a command from the processor 81, the power control section 97 controls the supply of power from the battery 98 to the above components.

Further, the battery 98 is connected to the lower terminal 27. When an external charging device (e.g., the cradle) is connected to the lower terminal 27 and power is supplied to the main body apparatus 2 via the lower terminal 27, the battery 98 is charged with the supplied power.

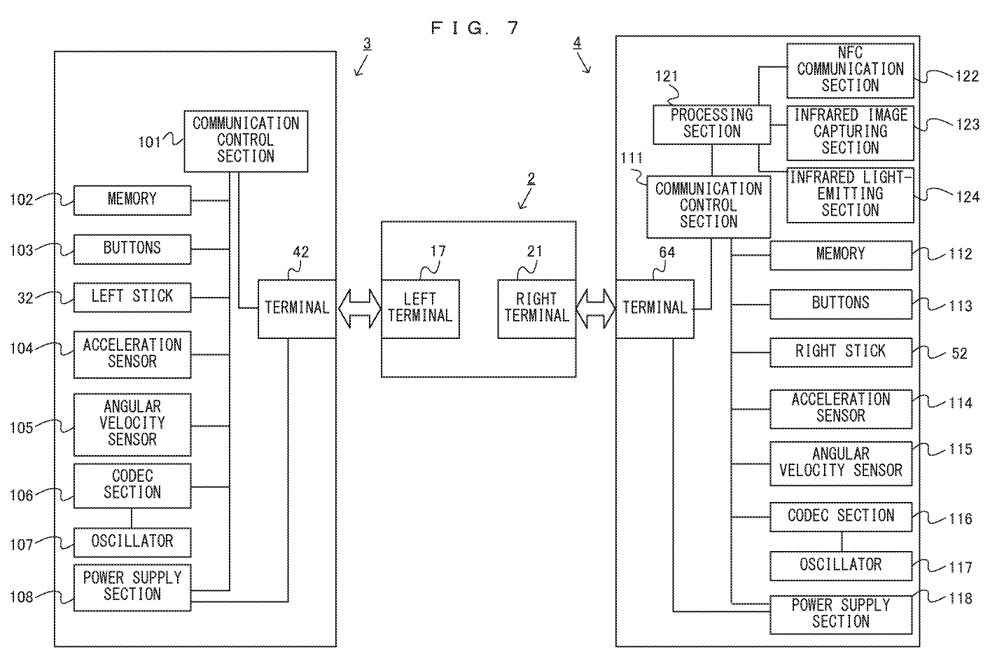

FIG. 7 is a block diagram showing examples of the internal configurations of the main body apparatus 2, the left controller 3, and the right controller 4. The details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the left stick 32. Each of the buttons 103 and the left stick 32 outputs information regarding an operation performed on itself to the communication control section 101 repeatedly at appropriate timings.

The left controller 3 includes inertial sensors. Specifically, the left controller 3 includes an acceleration sensor 104. Further, the left controller 3 includes an angular velocity sensor 105. In the exemplary embodiment, the acceleration sensor 104 detects the magnitudes of accelerations along predetermined three axial (e.g., x, y, z axes shown in FIG. 4) directions. The acceleration sensor 104 may detect an acceleration along one axial direction or accelerations along two axial directions. In the exemplary embodiment, the angular velocity sensor 105 detects angular velocities about predetermined three axes (e.g., the x, y, z axes shown in FIG. 4). The angular velocity sensor 105 may detect an angular velocity about one axis or angular velocities about two axes. Each of the acceleration sensor 104 and the angular velocity sensor 105 is connected to the communication control section 101. Then, the detection results of the acceleration sensor 104 and the angular velocity sensor 105 are outputted to the communication control section 101 repeatedly at appropriate timings.

The communication control section 101 acquires information regarding an input (specifically, information regarding an operation or the detection result of the sensor) from each of input sections (specifically, the buttons 103, the left stick 32, and the sensors 104 and 105). The communication control section 101 transmits operation data including the acquired information (or information obtained by performing predetermined processing on the acquired information) to the main body apparatus 2. The operation data is transmitted repeatedly, once every predetermined time. The interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the left stick 32 on the basis of the operation data. Further, the main body apparatus 2 can calculate information regarding the motion and/or the orientation of the left controller 3 on the basis of the operation data (specifically, the detection results of the acceleration sensor 104 and the angular velocity sensor 105).

The left controller 3 includes a vibrator 107 for notifying a user by vibration. In the exemplary embodiment, the vibrator 107 is controlled by a command from the main body apparatus 2. That is, when the communication control section 101 receives the above command from the main body apparatus 2, the communication control section 101 drives the vibrator 107 according to this command. Here, the left controller 3 includes a codec section 106. When the communication control section 101 receives the above command, the communication control section 101 outputs a control signal corresponding to the command, to the codec section 106. The codec section 106 generates a drive signal for driving the vibrator 107 from the control signal from the communication control section 101 and provides the drive signal to the vibrator 107. Accordingly, the vibrator 107 operates.

The vibrator 107 is more specifically a linear vibration motor. Unlike a normal motor that performs rotational motion, the linear vibration motor is driven in a predetermined direction according to an inputted voltage and thus can be vibrated at an amplitude and a frequency corresponding to the waveform of the inputted voltage. In the exemplary embodiment, the vibration control signal transmitted from the main body apparatus 2 to the left controller 3 may be a digital signal representing the frequency and the amplitude per unit time. In another exemplary embodiment, information indicating the waveform itself may be transmitted from the main body apparatus 2, but by transmitting only the amplitude and the frequency, the amount of communication data can be reduced. In addition, in order to further reduce the amount of data, only the differences from the previous values may be transmitted instead of the values of the amplitude and the frequency at that time. In this case, the codec section 106 converts the digital signal indicating the amplitude and frequency values acquired from the communication control section 101 into an analog voltage waveform and drives the vibrator 107 by inputting a voltage in accordance with this waveform. Therefore, the main body apparatus 2 can control the amplitude and the frequency for vibrating the vibrator 107 at that time, by changing the amplitude and the frequency transmitted per unit time. Each of the amplitude and the frequency transmitted from the main body apparatus 2 to the left controller 3 is not limited to one, and two or more amplitudes and two or more frequencies may be transmitted. In that case, the codec section 106 can generate a waveform of the voltage for controlling the vibrator 107 by synthesizing the waveforms that are indicated by the received multiple amplitudes and frequencies, respectively.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113, the right stick 52, and inertial sensors (an acceleration sensor 114 and an angular velocity sensor 115). These input sections have functions similar to those of the input sections of the left controller 3 and operate similarly to the input sections of the left controller 3.

The right controller 4 also includes a vibrator 117 and a codec section 116. The vibrator 117 and the codec section 116 operate in the same manner as the vibrator 107 and the codec section 106 of the left controller 3. That is, the communication control section 111 operates the vibrator 117, using the codec section 116, according to a command from the main body apparatus 2.

The right controller 4 includes a power supply section 118. The power supply section 118 has a function similar to that of the power supply section 108 of the left controller 3 and operates similarly to the power supply section 108.

### Outline of game processing in exemplary embodiment

Next, the outline of operation of game processing executed by the game system 1 according to the exemplary embodiment will be described. In the following description, the left controller 3 and the right controller 4 are collectively referred to simply as “controller”.

### Assumed game

Next, a game assumed in the exemplary embodiment will be described. In the game assumed in the exemplary embodiment, the user can freely place various objects within a virtual space (which may be either three‑dimensional or two‑dimensional) to create a virtual town space (hereinafter referred to as virtual town). In this example, a virtual “island” is prepared within the virtual space, and the user can create the virtual town on this island. Examples of objects that can be placed include building‑type objects (hereinafter simply referred to as building) and decoration‑type objects (hereinafter referred to as decorations). Examples of buildings include detached houses, apartment buildings, and shops. Examples of decorations include roads, street trees, potted plants, streetlights, and traffic signals. By performing predetermined operations on a predetermined edit screen, the user can place these objects at desired positions on the island.

Furthermore, in this game, the user can create virtual residents, which are virtual character objects, and place the virtual residents within the above virtual town. Each placed virtual resident acts autonomously and leads a virtual life. That is, the user can create virtual residents and allow the virtual residents to live in the virtual town. This game is a game in which the user creates a virtual town, places virtual residents within the virtual town, and observes how each virtual resident lives within the virtual town.

Here, each virtual resident is provided with a parameter referred to as a “human relationship parameter”, and virtual human relationships are constructed among the virtual residents. Examples of such relationships include “stranger”, “acquaintance”, “friend”, “romantic partner”, “spouse”, and “parent-child”. Based on the human relationship parameter, in‑game events (hereinafter simply referred to as “events”) may occur between virtual residents. The relationship parameter may also change as these events occur. For example, the virtual relationship may change from “friend” to “romantic partner”.

Among the events described above, an event (child‑birth event) may occur in which a virtual child character (hereinafter simply referred to as “child”) is generated based on a pair of virtual residents whose virtual human relationship is set to “spouse”. Details regarding the generation of such a child will be described later.

### Creation of virtual residents

Next, the processing for creating virtual residents to be placed in the virtual town will be described. In this game, the user can freely create, to some extent, the appearance of a virtual resident, specifically, a face image (hereinafter simply referred to as “face”), by using character parts. The created face of a virtual resident may also be edited. Hereinafter, an outline of the processing for generating and editing the face of a virtual resident according to the exemplary embodiment (hereinafter referred to as “face edit processing”) will be described.

In the exemplary embodiment, a plain object corresponding to the head of a virtual resident (a head object) is used as a part placement area. In the head object, “regions” such as eyes and nose are set, and a face can be created by, in the respective regions, designating and placing “character part objects” (hereinafter simply referred to as “parts”) corresponding to the regions. In this example, description will be given with a case where, as the regions (types of parts), eight types, that is, “face shape”, “hairstyle”, “eyebrows”, “eyes”, “nose”, “mouth”, “ears”, and “others”, are set. In the “others” region, for example, parts such as glasses, facial hair, wrinkles, and the like can be placed. Strictly speaking, with respect to the “face shape”, the shape of the head object is modified to match the designated face shape; however, for convenience, this is also treated as one type of “placement” in the following description. Hereinafter, the parts corresponding to these eight types of regions may be collectively referred to as “basic parts”. Furthermore, in the exemplary embodiment, in addition to the basic parts, it is also possible to create and place a part referred to as “face paint” (hereinafter abbreviated as “FP”), which will be described later, as an “additional part”. In the following description, the term “parts” refers collectively to both the basic parts and the additional parts.

The placement of the basic parts and the additional part on the head object may take any of the following modes: (1) a mode in which each part is directly drawn onto the head object; (2) a mode in which each part is overlaid on the head object; or (3) a hybrid mode in which some parts are directly drawn while others are overlaid. In the exemplary embodiment, description will be given using the mode (2), in which each part is overlaid on the head object.

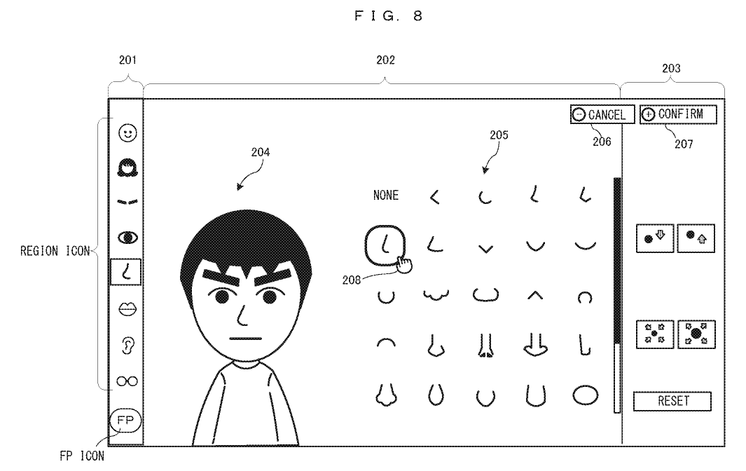

FIG. 8 shows an example of a game screen for creating and editing the face of a virtual resident (hereinafter also referred to as “basic edit screen”). In FIG. 8, a region selection area 201 is shown on the left side of the basic edit screen, an adjustment operation area 203 on the right side, and a part selection area 202 in the center. In the region selection area 201, a UI for selecting a region to be edited is displayed; specifically, region icons corresponding to the above eight types of regions are arranged vertically. At the bottom, an FP icon for transitioning to an FP creation screen described later is shown. In the part selection area 202, a virtual resident image 204 is displayed on the left side, and a parts list 205 is displayed on the right side. A cancel button 206 and a confirm button 207 are also displayed at the upper right of the screen. Through operations on this screen, the user can edit appearance parameters representing the appearance in the game. Examples of the appearance parameters include parameters representing the shape, size, placement position, placement angle, color, etc., of the basic parts, as described below. Hereinafter, for convenience of description, among various parameters included in the appearance parameters, the parameters other than the shape are collectively referred to as “adjustment parameters”.

On such a screen, when the user operates a finger‑shaped cursor 208 to select a region to be edited from the region selection area 201, the parts list 205 showing basic parts having various shapes corresponding to the selected region is displayed. FIG. 8 illustrates an example in which “nose” is selected as the region. By moving the cursor 208 onto one of the basic parts in the parts list 205 and pressing a predetermined button, the virtual resident image 204 is displayed with the selected basic part temporarily placed therein. In other words, the user edits the “shape” of the basic part corresponding to the selected region as part of the appearance parameters. In the example of FIG. 8, the basic part of the shape shown second from the top in the leftmost column of the parts list 205 is selected. Therefore, in the virtual resident image 204, this basic part is temporarily placed in the nose region. When basic parts (and an FP described later) for the respective regions are temporarily placed through such operations and the confirm button 207 at the upper right is finally selected, the edit content at that time is finalized, and data of the virtual resident with the parts formally placed is saved. When the cancel button 206 is selected, the edit content is discarded, and the basic edit screen is exited. In another exemplary embodiment, the basic edit screen may be exited after the edit content is saved.

In the adjustment operation area 203, a UI for adjusting the above adjustment parameters of the temporarily placed basic part is displayed. Examples of adjustable contents include enlarging or reducing the temporarily placed basic part, finely adjusting its placement position, finely adjusting its placement angle, and adjusting the color of the basic part. In the adjustment operation area 203, the content corresponding to the region currently being edited may also be displayed as appropriate. For example, when the region is “eyes”, a UI for adjusting eye color is displayed in the adjustment operation area 203. When the region is “nose”, a UI for color adjustment may not necessarily be displayed. Thus, for example, when the region is “eyes”, the user can select an eye basic part from the parts list 205 and also operate the adjustment operation area 203 to finely adjust the RGB ratios of the eye color. The various parameters adjusted as described above are saved as part of the data constituting the virtual resident (adjustment parameters 336 in FIG. 19 described later) at the time when the edit content is finalized.

### Non-display setting of parts

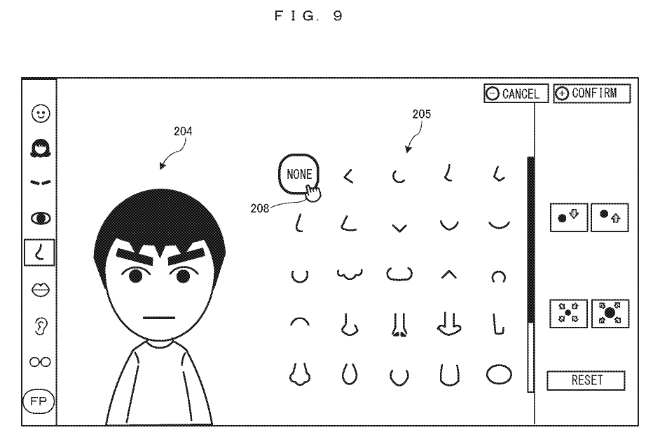

In the exemplary embodiment, for each region, it is possible to set a basic part to non-display. FIG. 9 shows an example in which the “nose” is set to non-display. When the user desires to hide the basic part for a certain region, the basic part for this region can be set to non-display by selecting “None” at the upper left of the parts list 205.

### Face paint

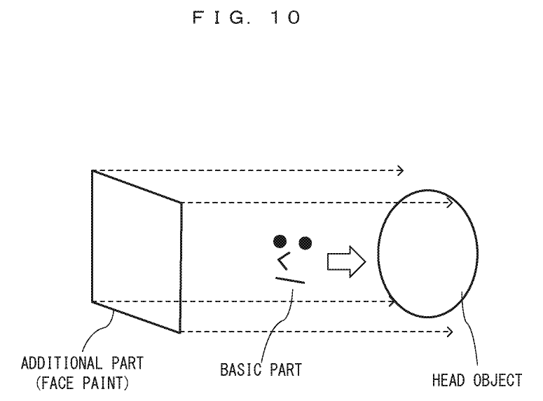

In the exemplary embodiment, in addition to the above basic parts, an additional part referred to as FP can be created. The FP is, for example, a transparent plate‑shaped part. The user can hand‑draw a pattern or the like on the FP, and the FP can then be placed so as to overlap the basic parts. FIG. 10 is a schematic diagram illustrating the relationship among the head object, the basic parts, and the FP. After the basic parts are placed on the head object as described above, the FP is placed further on top. Since the pattern or the like on the FP is drawn by the user, the degree of freedom in creating the character’s face can be increased. For example, all of the basic parts may be set to non-display, and then an FP hand‑drawn over the entire face may be created and placed.

The front‑back relationship between the basic parts and the FP can be set by the user. By default, the FP is positioned at the frontmost layer; however, depending on the settings, the basic parts may be placed in front, with the FP placed behind the basic parts.

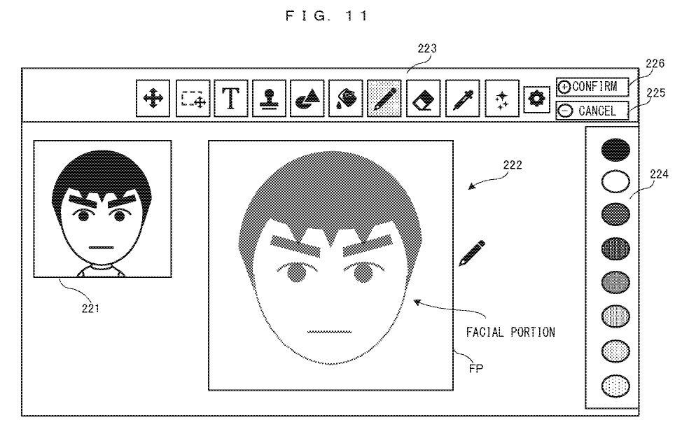

As one example of the FP, a case in which the “nose” is set to non-display and a nose illustration hand‑drawn by the user is used as the FP will be described. FIG. 11 illustrates an example of an edit screen for generating and editing an FP (hereinafter also referred to as FP edit screen). In this example, this screen can be transitioned to by selecting the FP icon located at the bottom of the region selection area 201 on the above basic edit screen. Of course, it is also possible to allow the FP edit screen to be transitioned to through other operations. Furthermore, an FP may not necessarily be created. That is, an FP can be generated for each virtual resident, and the user may individually generate an FP suitable for the particular virtual resident for which the FP is to be created.

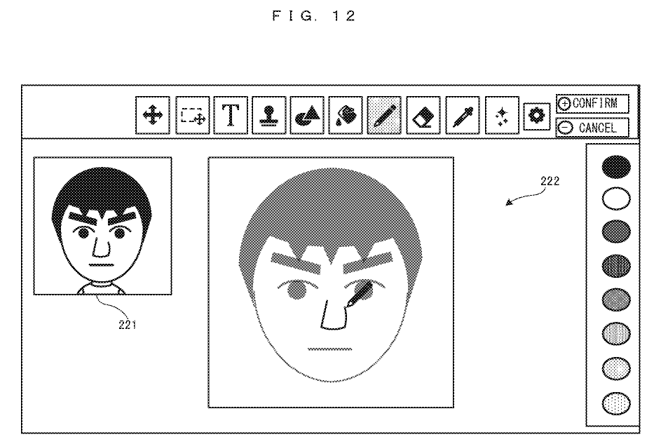

In FIG. 11, a preview area 221 showing the face of the virtual resident is displayed on the left side of the FP edit screen. In the vicinity of the center, an FP drawing area 222 is displayed. In the FP drawing area 222, an enlarged face portion is shown, and an FP that is a transparent plate image is overlaid thereon. In a tool selection area 223 at the top of the FP edit screen, the user can select various drawing tools. In a color selection area 224 at the right edge of the FP edit screen, the user can designate drawing colors. A cancel button 225 and a confirm button 226 are also displayed at the upper right of the screen. Using the various drawing tools and drawing colors, the user can draw any desired image (such as patterns or characters) in the FP drawing area 222. As an example, a case in which the user hand‑draws a “nose” as shown in FIG. 12 is assumed. When the user performs image drawing operations in the FP drawing area 222, the results are immediately reflected in the preview area 221, allowing the user to confirm the final appearance. When the confirm button 226 is selected, the FP edit content at that time is finalized, and data of the FP is saved. When the cancel button 225 is selected, the edit content is discarded, and the FP edit screen is exited to return to the basic edit screen.

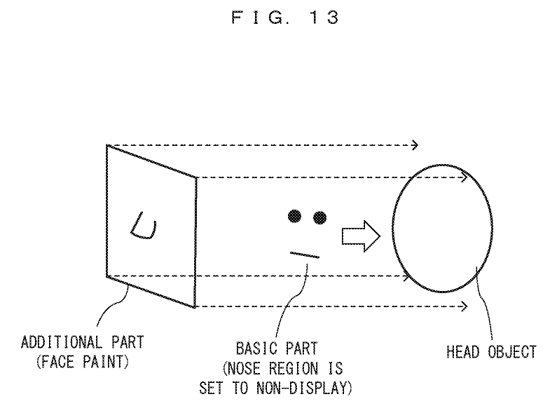

FIG. 13 is a schematic diagram illustrating the relationship when placing the FP created as in FIG. 12. In FIG. 13, the basic parts are placed on the head object, but the “nose” is set to non-display, and on top of this, the transparent plate‑like FP with the hand‑drawn nose is placed. As a result, as shown in the preview area 221 in FIG. 12, a virtual resident whose final appearance includes a nose that is the only hand‑drawn element is generated.

In addition, as with the basic parts described above, it is possible to adjust appearance parameters for the FP (hereinafter sometimes referred to as “FP parameters”), including its shape, scaling, fine adjustment of its position and angle, and the like. Although, in the present example, the FP is exemplified as a transparent rectangular plate‑shaped object, the FP shape may alternatively be deformable by the user.

In addition to generating the face of the virtual resident as described above, the user may also designate a body type, clothing, etc.

### Child generation processing

In this game, as described above, a child‑birth event may occur based on two virtual residents who are set as a pair with each other as “spouses”. Since a child is also a virtual resident, its face can be generated by placing various parts onto a head object, as in the above. In this game, the child’s face is automatically generated by inheriting (genetically) the parts used in the faces of virtual residents who are its parents. For example, the basic part for the eyes may be taken from one parent (hereinafter, the first parent), while the basic part for the nose may be taken from the other parent (hereinafter, the second parent).

Here, as described above, this game has the element of setting a basic part for each region to non-display and the element of the FP when the user generates a virtual resident’s face. Considering these elements, if a method in which, for example, parts are simply selected at random from either parent is used when generating a child’s face, the resulting appearance of the child’s face may become unnatural. For example, a case in which the parents have the following settings for the basic part for the eyes is assumed.

First parent: The basic part for the eyes is set to non-display, and an FP on which hand‑drawn eyes are drawn is used.

Second parent: The basic part for the eyes is set to display, and no FP is used.

In such a case, if parts are selected at random to generate a child’s face, it is considered that the following settings may be made.

Child: The basic part for the eyes inherited from the second parent is set to display, and the FP inherited from the first parent is also set to display.

As a result, it is considered that the child’s face may have two sets of eyes, the eyes inherited from the second parent and the hand‑drawn eyes (FP) inherited from the first parent, producing an unnatural appearance.

Accordingly, in the exemplary embodiment, the following control is performed. A parent to be preferentially inherited (hereinafter, “priority parent”) is first determined. If the basic part for a certain region is set to non-display in the priority parent, then the corresponding basic part for the child is also set to non-display. Furthermore, if the priority parent uses an FP, then this FP is placed for the child.

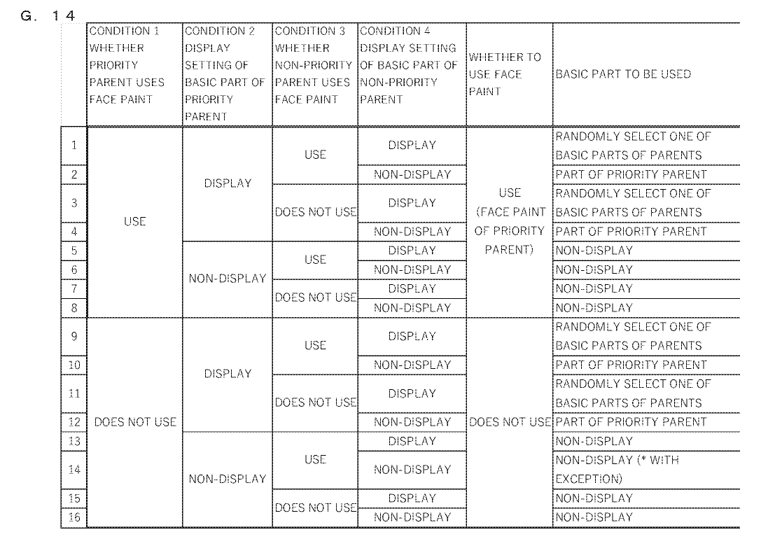

The table shown in FIG. 14 illustrates the relationship between the part settings of the parents and the part settings used for the child (i.e., the inheritance relationship of parts) in this example. In the exemplary embodiment, for each region in the child, the display/non‑display setting and basic parts to be used when set to display are determined.

First, prior to determining the parts to be used for the child, the above‑described priority parent is determined. Which of the two parents is selected as the priority parent may be determined at random or may be selected by the user. The parent who is not selected as the priority parent is hereinafter sometimes referred to as “non‑priority parent”.

Once the priority parent has been determined, each part to be used for the child is determined according to four conditions listed below, with the relationship shown in FIG. 14.
Condition 1: Whether the priority parent uses an FP
Condition 2: Display/non‑display setting of the part for each region in the priority parent
Condition 3: Whether the non‑priority parent uses an FP
Condition 4: Display/non‑display setting of the part for each region in the non‑priority parent

In FIG. 14, first, in the case where the priority parent uses an FP in “Condition 1” (patterns 1 to 8), the FP of the priority parent is also inherited and used for the child. Furthermore, in the case where the priority parent uses an FP in “Condition 1” and the basic part for the region for which determination is to be performed (hereinafter referred to as “determination target region”) is set to “display” in “Condition 2” (patterns 1 to 4), then if the display setting for the determination target region in the non‑priority parent is “display” in “Condition 4”, either one of the basic parts of the parents is selected at random for that region (patterns 1 and 3). If the display setting for the determination target region in the non‑priority parent is “non‑display” in “Condition 4”, the basic part of the priority parent is selected for the determination target region (patterns 2 and 4).

Moreover, in the case where the priority parent uses an FP in “Condition 1” and the basic part for the determination target region is set to “non‑display” in “Condition 2”, then regardless of the settings of the non‑priority parent (Conditions 3 and 4), the basic part for that region in the child is set to non‑display (patterns 5 to 8).

Next, in the case where the priority parent does not use an FP in “Condition 1” (patterns 9 to 16), the child is also set not to use an FP (that is, no FP is placed on the head object). In this case, even if the non‑priority parent uses an FP, the child will not use an FP as long as the priority parent does not use an FP. This is because, if the priority parent does not use an FP, it is highly likely that some basic parts are placed. In such a case, if the face paint of the non‑priority parent contains a hand‑drawn depiction in a certain region, when the FP of the non‑priority parent is used for the child, the basic part of the priority parent and the image of the hand‑drawn depiction in the certain region in the FP of the non‑priority parent may overlap, producing an unnatural appearance. Therefore, if the priority parent does not use an FP, the child is, as a general rule, set not to use an FP regardless of whether or not the non‑priority parent uses an FP (however, an exception exists for “pattern 14”, which will be described later).

Furthermore, in the case where the priority parent does not use an FP in “Condition 1” and the basic part for the determination target region is set to “display” in “Condition 2” (patterns 9 to 12), then if the display setting for that region in the non‑priority parent is “display” in “Condition 4”, either one of the basic parts of the parents is selected at random for that region (patterns 9 and 11). On the other hand, if the display setting for the determination target region in the non‑priority parent is “non‑display” in “Condition 4”, the basic part of the priority parent is selected for that region (patterns 10 and 12).

Conversely, in the case where the priority parent does not use an FP in “Condition 1” and the basic part for the determination target region is “non-display” in “Condition 2” (patterns 13 to 16), then, in principle, the basic part for that region in the child is set to non‑display.

The above setting process is repeated until the display/non‑display setting for a certain region and the basic part to be used for that region have been determined. Examples of such certain regions include “eyes”, “eyebrows”, “nose”, “mouth”, and “ears”, and, for other regions such as “hairstyle” and “face shape”, such determination may not necessarily be performed through the above setting process. Alternatively, as a modification, for all regions, such determination may be performed through the above setting process.

Here, supplementary description will be given regarding pattern 14 in FIG. 14. If the priority parent does not use an FP in “Condition 1”, the basic part for the determination target region is set to “non-display” in “Condition 2”, the non‑priority parent uses an FP in “Condition 3”, and the basic part for the determination target region is set to non‑display in “Condition 4”, then, in principle, the basic part of the child for that region is also set to non‑display.

However, in this case, in the case where the basic parts of the priority parent are set to non-display for “all regions” in “Condition 2”, the non‑priority parent uses an FP in “Condition 3”, and the basic parts of the non‑priority parent are set to non-display for “all regions” in “Condition 4”, either “setting (all) basic parts to non-display” or “using the FP of the non‑priority parent” is selected at random for the face of the child. That is, if both parents have a so-called “blank face” and only the non‑priority parent use an FP, then, as an exception, the FP of the non‑priority parent may be used for the child. Accordingly, the likelihood that the child’s face becomes “blank” is reduced. This is because, in the case where all basic parts are set to non-display and an FP is used, the FP is considered to be used for the entire face image (content corresponding to all basic parts), and thus, if all basic parts of both parents are set to non-display and only the non‑priority parent uses an FP, it is considered that inheriting that FP can result in a natural‑looking face for the child. Whether or not to use the FP of the non‑priority parent is determined at random, and therefore the possibility that the child’s face becomes “blank” is not eliminated.

In the case where the priority parent has “all basic parts set to non‑display and does not use an FP (this setting state is referred to as fully blank face state)”, and the non‑priority parent uses an FP but has at least one basic part set to display (pattern 13), the FP of the non‑priority parent is not used. This is because, if at least one basic part is set to display, it is considered that it is highly likely that the FP by itself does not provide images corresponding to all facial regions. In this regard, in another exemplary embodiment, in the case where the priority parent has all basic parts set to non‑display and does not use an FP, and the non‑priority parent has at least one basic part set to display, the child may be caused to inherit the basic part set to display from the non‑priority parent regardless of whether or not the non‑priority parent uses an FP. Furthermore, in this case, if the non‑priority parent uses an FP, both the FP and the basic part set to display may be inherited.

That is, in the case where the priority parent is in a “fully blank face state” but the non‑priority parent is not in a “fully blank face state”, it means that a possibility remains that the basic parts or the FP of the non‑priority parent will be used for the child when generating a child’s face.

In the exemplary embodiment, for the placement position of each part in the child, the position of the priority parent is inherited. For example, even if the part itself for the “eyes” region is inherited from the non‑priority parent, the placement position is based on the “eye” placement position of the priority parent (including one obtained by fine‑adjustment of the above adjustment parameters). Accordingly, a child that inherits more of the features of the priority parent can be generated.

Furthermore, the appearance parameters for the basic parts and the FP determined as described above are further adjusted as appropriate for use for the child. For example, the appearance parameters are adjusted as appropriate such that the child’s face appears natural, for example, “the placement positions are adjusted such that the parts are gathered closer to the center of the face”, or “the scale is set slightly smaller”.

When the FP is inherited by the child, the setting of the above-described front‑back relationship between the FP and the basic parts is also inherited directly from the priority parent.

Furthermore, for certain basic parts such as “wrinkles” or “facial hair”, control may be performed such that these basic parts are not inherited by the child even when set for both parents. In addition, for the “hairstyle” region, the hairstyle for the child is determined based on the hairstyles of both parents. Therefore, the hairstyle for the child does not necessarily match the hairstyle of either one of both parents. For example, a hairstyle different from the hairstyles of both parents may be selected.

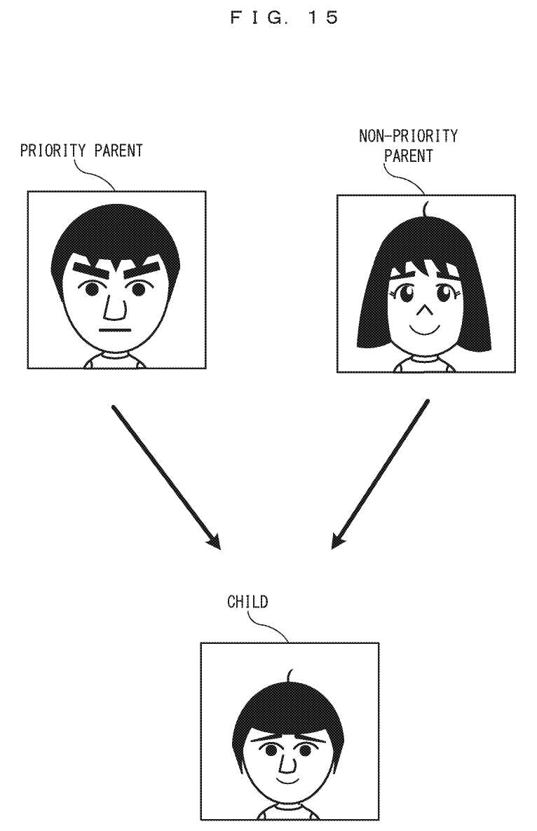

FIG. 15 illustrates an example of generating a child’s face. In FIG. 15, the priority parent uses an FP and has the nose region set to non‑display, and a face image in which only the nose is hand‑drawn as shown in FIG. 12 is generated. In addition, the non‑priority parent does not use an FP. Focusing on the nose region, both parents each have a face in which an image is displayed at the nose region (a face with a nose). Meanwhile, an image in which the non‑display setting of the priority parent is inherited for the nose region in the child and the FP of the priority parent is inherited is generated. That is, the hand‑drawn nose of the priority parent is inherited by the child (pattern 7 in FIG. 14).

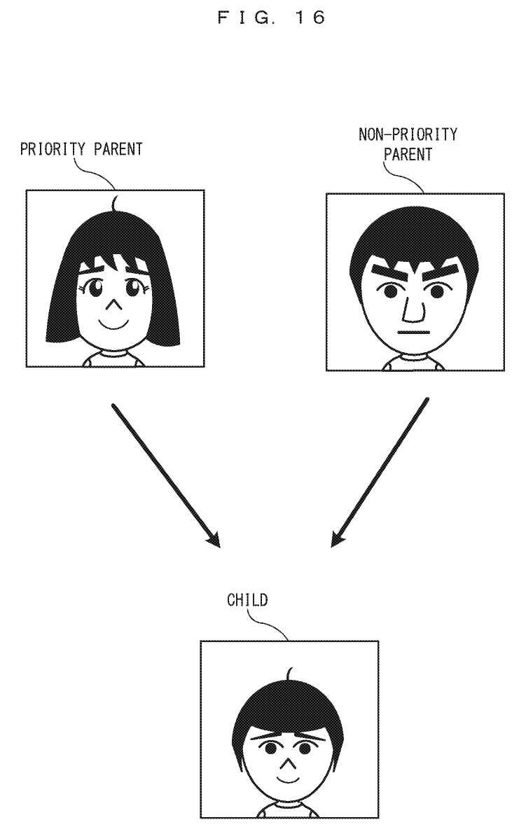

FIG. 16 illustrates another example of generating a child’s face. FIG. 16 illustrates an example of a child’s face in the case where the priority parent and the non‑priority parent in FIG. 15 are swapped. In FIG. 16, the priority parent does not use an FP and has all regions for the basic parts set to display. In addition, in FIG. 16, the non‑priority parent uses an FP and has the nose region set to non‑display, and the face image thereof is an image in which only the nose is hand‑drawn as shown in FIG. 12. In this case, since the priority parent does not use an FP, the child is also determined not to use an FP. Focusing on the nose region, the priority parent has the nose region set to display and the non‑priority parent has the nose region set to non‑display; thus, as a result, the nose part of the priority parent is inherited by the child (pattern 12 in FIG. 14). For ease of description, FIG. 16 illustrates the same parts as FIG. 15 for the regions other than the nose, but, depending on the combination of the four conditions described above, it is also possible that the parent basic parts that are not inherited in FIG. 16 may be inherited for the other regions.

For the child generated as described above, a plurality of growth stages from childhood to adulthood may be set. As the growth stage progresses, the appearance parameters of the child such as the above‑described adjustment parameters may be updated as appropriate such that the placement of each part gradually approaches that of the face of the priority parent.

### Data to be used

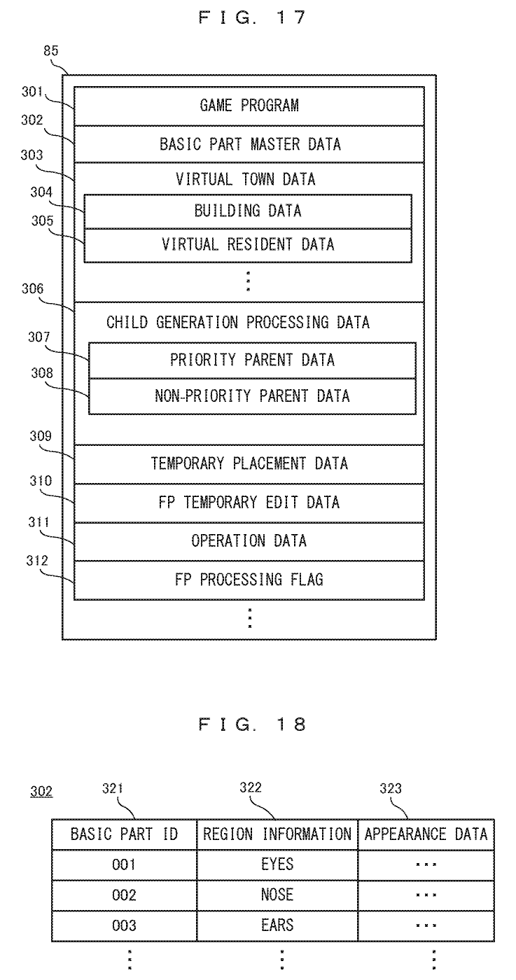

Next, various data to be used in the game processing will be described. FIG. 17 is a memory map showing an example of various data stored in the DRAM 85 of the main body apparatus 2. The content of each data will be described below.

A game program 301 is a program for executing the game processing described above.

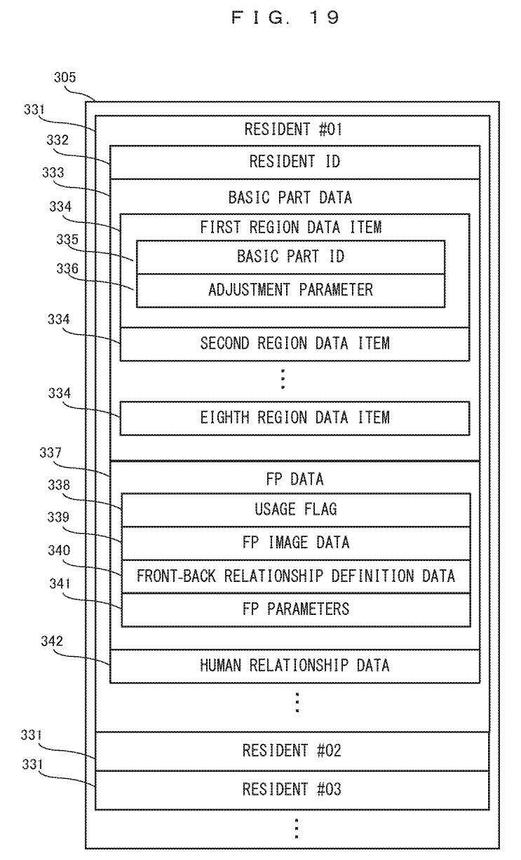

Basic part master data 302 is data that defines the basic parts to be used in this game. FIG. 18 shows the data structure of the basic part master data 302. The basic part master data 302 is data composed of a set of records each having items including a basic part ID 321, region information 322, and appearance data 323. The basic part ID 321 is information for uniquely identifying each basic part. The region information 322 is information indicating which region the basic part corresponds to. In this example, information indicating one of the eight types of regions described above is set as the region information 322. The appearance data 323 is data indicating the appearance of each basic part. For example, the appearance data 323 may include 3D model data, texture data, etc.

Referring back to FIG. 17, virtual town data 303 is data that defines the structure, etc., of the virtual town. The virtual town data 303 includes at least building data 304 and virtual resident data 305.

The building data 304 is data regarding various buildings placed within the virtual town. For example, data indicating the placement position of each building, the type of the building, etc., is included.

The virtual resident data 305 is data regarding virtual residents that can be placed within the virtual town. FIG. 19 shows an example of the data structure of the virtual resident data 305. The virtual resident data 305 includes a plurality of individual resident data items 331 corresponding to the respective virtual residents. Each individual resident data item 331 includes at least a resident ID 332, basic part data 333, FP data 337, and human relationship data 342.

The resident ID 332 is information for uniquely identifying each virtual resident.

The basic part data 333 includes a plurality of nth region data items 334 (where n is an integer) regarding the respective regions constituting a face. In this example, since there are eight types of regions, eight region data items 334 (first region data item through eighth region data item) are included. Each region data item 334 includes at least a basic part ID 335 and adjustment parameters 336. The basic part ID 335 is information indicating the basic part set for that region and is information corresponding to the basic part ID 321 in the basic part master data 302. In other words, the basic part ID 335 can be regarded as a parameter indicating the shape of the basic part to be placed in that region, among the above-described appearance parameters. If the basic part is set to non‑display, a value indicating non‑display (i.e., that no basic part is placed), such as a Null value, is set as the basic part ID 335. The adjustment parameters 336 are parameters that are the stored adjustment parameters described above.

Next, the FP data 337 is data regarding the above FP. The FP data 337 includes at least a usage flag 338, FP image data 339, front‑back relationship definition data 340, and FP parameters 341. The usage flag 338 is a flag indicating whether the virtual resident uses an FP (i.e., an FP is placed on its face), and if an FP is used, the usage flag 338 is set to ON. The FP image data 339 is data indicating the actual image content of the FP, such as two‑dimensional image data. The front‑back relationship definition data 340 is data that defines the front‑back relationship between the FP and the basic parts. That is, the front‑back relationship definition data 340 is data indicating whether the FP is placed in front of or behind the basic parts on the head object. The FP parameters 341 correspond to the appearance parameters of the FP (including its shape parameter and the above adjustment parameters).

The human relationship data 342 is data indicating the human relationships between the virtual resident and other virtual residents. The human relationship data 342 includes, for each of the other virtual residents, various types of human relationship‑related data such as “affinity information” indicating an affinity level, “current relationship information” indicating the current relationship status (e.g., friend, romantic partner), and “feelings information” indicating the current feelings toward the other virtual resident.

Although not shown, each individual resident data item 331 also includes data regarding appearances other than the face, such as the body type, clothing, etc., of the virtual resident.

Referring back to FIG. 17, child generation processing data 306 includes various data to be used in the above‑described processing for generating a child. The child generation processing data 306 includes at least priority parent data 307 and non‑priority parent data 308. The priority parent data 307 is information for identifying the priority parent among both parents, and the non‑priority parent data 308 is information for identifying the non‑priority parent. As each of these, the resident ID 332 of one of the virtual residents serving as parents can be set.

Temporary placement data 309 is data for temporarily storing various pieces of information regarding basic parts temporarily placed in the processing related to the above edit screen. In other words, the temporary placement data 309 is data of a face image during editing and can be updated in real time. The virtual resident image 204 displayed in the part selection area 202 is an image based on this temporary placement data.

FP temporary edit data 310 is data for temporarily storing an FP image and various setting contents during editing. That is, the FP temporary edit data 310 is data of the FP during editing and can be updated in real time during FP editing operations.

Operation data 311 is data indicating the contents of various operations performed on the controller. For example, the operation data 311 includes data indicating the pressed state of each button and data indicating the tilt direction and tilt amount of the stick.

An FP processing flag 312 is a flag used to determine whether to perform processing related to the basic edit screen or processing related to the FP edit screen in processing related to the edit screen, which will be described later. By default, the FP processing flag 312 is set to OFF, and when the FP processing flag 312 is ON, it indicates that the processing related to the FP edit screen is to be performed.

### Details of game processing

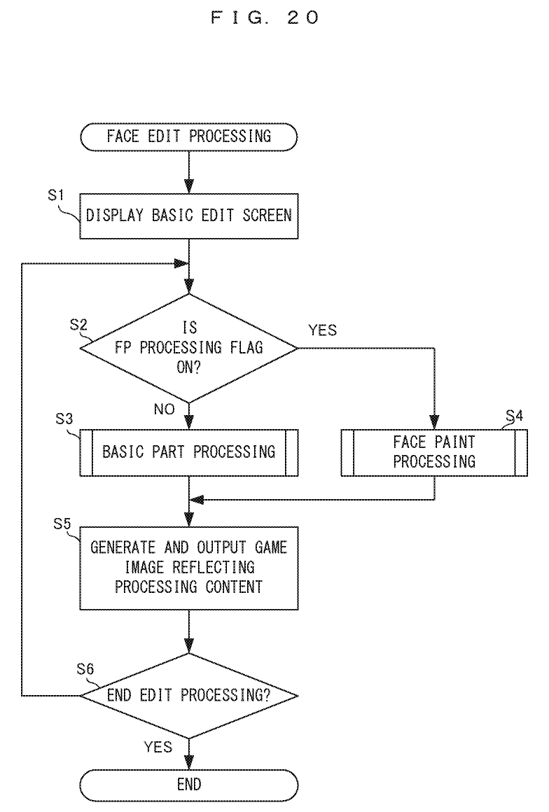

Next, the details of the game processing in the exemplary embodiment will be described with reference to FIGS. 20-24. Here, “face edit processing” for creating the face of the above virtual resident and “child face part determination processing” which can be executed when a child‑birth event occurs will be described, and the description of other game processing is omitted. The processing described in the following flowcharts may include other processing, and part of the processing may be omitted. The order of each process is merely an example, and, for example, the processes may be executed simultaneously or in reverse order. Furthermore, the processes are described as being separated for convenience, but may be implemented as an integrated process. The following processes may also be executed at a predetermined interval (e.g., per processing frame or every 1/30 seconds).

### Face edit processing

FIG. 20 is an example of a flowchart showing processing related to the “face edit processing”. In FIG. 20, first, the processor 81 generates and displays the basic edit screen as shown in FIG. 8 above (S1). When creating a new virtual resident, a face for a virtual resident on which default basic parts are placed is generated as the temporary placement data 309, and a basic edit screen showing a face based on the temporary placement data 309 (default face) is generated. In addition, when editing an existing virtual resident, data of a face based on the basic part data 333 currently set for that virtual resident is generated as the temporary placement data 309, and a basic edit screen showing a face based on the temporary placement data 309 (current face) is generated.

Next, the processor 81 determines whether or not the FP processing flag 312 is ON (S2). If, as a result of the determination, the FP processing flag 312 is OFF (NO in S2), the processor 81 executes basic part processing (S3). On the other hand, if the FP processing flag 312 is ON (YES in S2), the processor 81 executes face paint processing (S4).

### Basic part processing

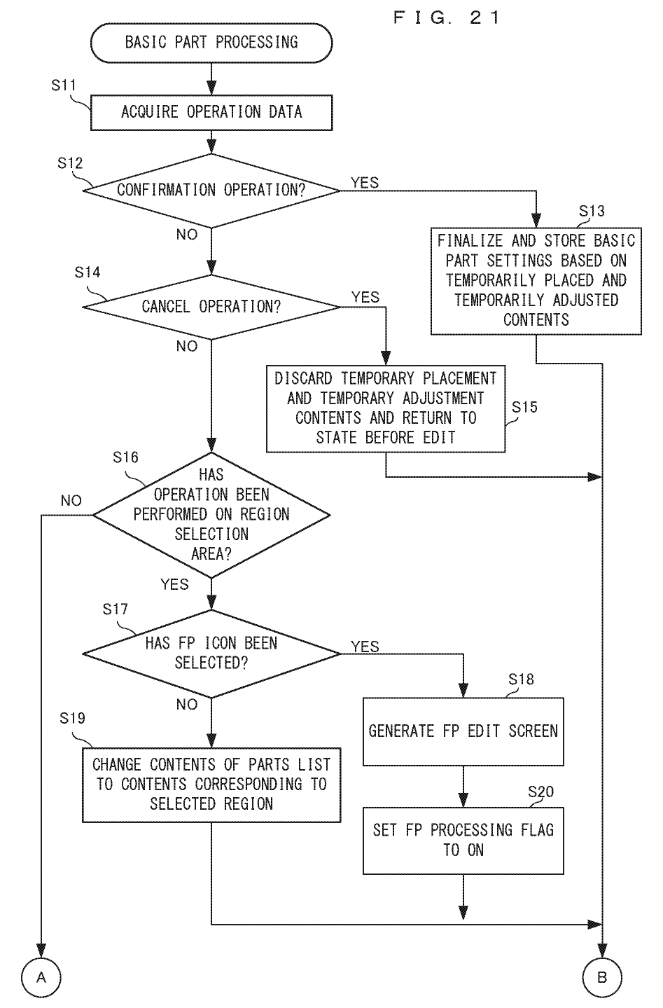

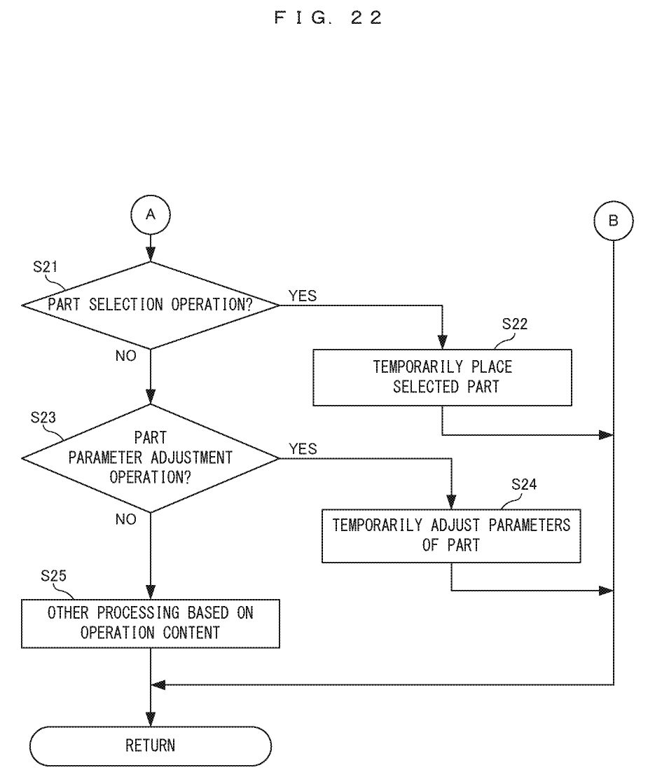

FIGS. 21 and 22 are flowcharts showing the details of the basic part processing. In FIG. 21, first processor 81 acquires the operation data 311 (S11). Next, the processor 81 determines whether or not a confirmation operation for confirming the edit content (operation on the confirm button 207 in FIG. 8) has been performed (S12). If the confirmation operation has not been performed (NO in S12), the processor 81 determines whether or not a cancel operation (operation on the cancel button 206 in FIG. 8) has been performed (S14). If, as a result of the determination, the cancel operation has not been performed (NO in S14), next, the processor 81 determines whether or not an operation has been performed on the region selection area 201 (S16). If, as a result of the determination, an operation has been performed on the region selection area 201 (YES in S16), the processor 81 determines whether or not the above FP icon has been selected (S17), that is, whether an operation for transitioning to the FP edit screen has been performed is determined. If, as a result of the determination, the FP icon has not been selected, that is, one of the region icons has been selected (NO in S17), the processor 81 updates the temporary placement data 309 based on the edit content at that time, and changes the display content of the basic parts list 205 to a content corresponding to the selected region icon (S19). Then, the basic part processing ends.

On the other hand, if, as a result of the determination in S17, the FP icon has been selected (YES in S17), the processor 81 generates the FP edit screen as shown in FIG. 11 (S18). Next, the processor 81 sets the FP processing flag 312 to ON (S20). Then, the basic part processing ends.

On the other hand, if, as a result of the determination in S16 above, no operation has been performed on the region selection area 201 (NO in S16), the processor 81 determines whether or not an operation for selecting one of the shapes of the basic parts from the parts list 205 has been performed (S21). If, as a result of the determination, an operation for selecting one of the shapes of the basic parts has been performed (YES in S21), the processor 81 updates the temporary placement data 309 based on the selected basic part and generates the virtual resident image 204 in which the selected basic part is placed (S22). If non‑display setting is selected as shown in FIG. 9, a value indicating that this region is set to non-display is also stored in the temporary placement data 309. Accordingly, the virtual resident image 204 in which no basic part is placed in this region is generated. Then, the basic part processing ends.

On the other hand, if an operation for selecting a basic part has not been performed (NO in S21), the processor 81 determines whether or not an operation on the adjustment operation area 203, that is, an operation for adjusting the adjustment parameters, has been performed (S23). If, as a result of the determination, an operation for adjusting the adjustment parameters has been performed (YES in S23), the processor 81 adjusts the adjustment parameters based on the content of the operation and stores the adjusted content in the temporary placement data 309 (S24). Then, the basic part processing ends.

On the other hand, if an operation for adjusting the adjustment parameters has not been performed (NO in S23), the processor 81 executes other processing based on the content of the operation (S25). For example, processing for enlarging or reducing the virtual resident image 204 itself, etc., are executed.

Next, processing performed if, as a result of the determination in S12 above, the confirmation operation has been performed (YES in S12), will be described. In this case, the processor 81 performs a process of finalizing and storing the edit content at that time. That is, a process of updating the basic part data 333 based on the contents of the temporary placement data 309 is executed (S13). In other words, the basic part ID 335, which is the shape parameter of each region, and the adjustment parameters 336 are updated. Then, the basic part processing ends.

Next, processing performed if, as a result of the determination in S14 above, the cancel operation has been performed (YES in S14), will be described. In this case, the processor 81 discards the edit content at that time and returns the virtual resident image 204 to the state before editing began. Then, the basic part processing ends.

### Face paint processing

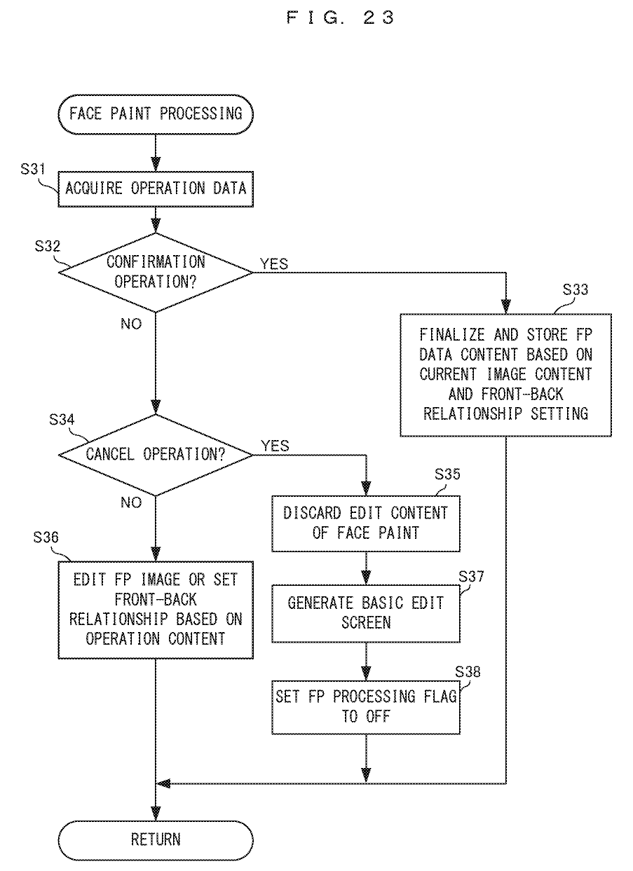

Next, the face paint processing corresponding to the processing in S4 above will be described. FIG. 23 is a flowchart showing the details of the face paint processing. In FIG. 23, first, the processor 81 acquires the operation data 311 (S31).

Next, the processor 81 determines whether or not a confirmation operation for confirming the FP edit content (operation on the confirm button 226 in FIG. 11) has been performed (S32). If the confirmation operation has not been performed (NO in S32), the processor 81 determines whether or not a cancel operation (operation on the cancel button 225 in FIG. 11) has been performed (S34). If, as a result of the determination, the cancel operation has not been performed (NO in S34), next, the processor 81 performs a process of rendering and editing an FP image, a process of adjusting the FP parameters, or a process of setting the front-back relationship between the FP and the basic parts, based on the content of the operation (S36). The edit content at that time is stored in the FP temporary edit data 310. Then, the face paint processing ends.

On the other hand, if, as a result of the determination in S32 above, the confirmation operation has been performed (YES in S32), a process of finalizing and storing the edit content at that time is performed. That is, a process of updating the FP data 337 based on the contents of the FP temporary edit data 310 is performed (S33). The FP data 337 may be updated when the confirmation operation is performed on the basic edit screen (YES in S12).

On the other hand, if, as a result of the determination in S34 above, the cancel operation has been performed (YES in S34), the processor 81 discards the FP edit content at that time (S35). Next, the processor 81 generates the basic edit screen (S37) and sets the FP processing flag 312 to OFF (S38). Then, the basic part processing ends.

Referring back to FIG. 20, next, the processor 81 generates and outputs a game image reflecting the processing described above (S5).

Next, the processor 81 determines whether or not a condition for ending the face edit processing has been satisfied (S6). If the ending condition has not been satisfied (NO in S6), the processor 81 returns to S2 and repeats the processing. If the ending condition has been satisfied (YES in S6), the face edit processing ends.

### Child face part determination processing

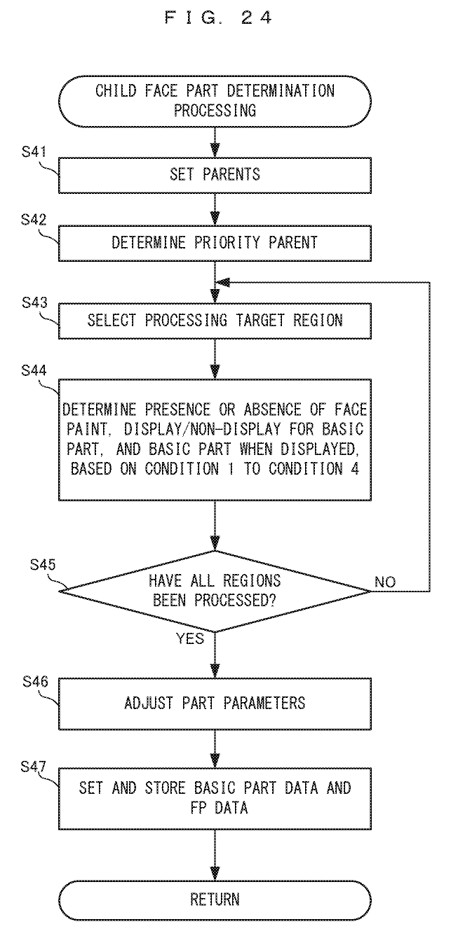

Next, the child face part determination processing will be described. This processing may be executed as part of the processing related to the child‑birth event. FIG. 24 is a flowchart showing the details of the child face part determination processing. In FIG. 24, first, the processor 81 sets virtual residents who will serve as parents (S41). Next, the processor 81 determines one of the parents as the priority parent (S42). Based on this determination, the contents of the child generation processing data 306 are also set as appropriate.

Next, the processor 81 determines one region for which the following processing is to be performed (i.e., an unprocessed target region) from the above eight types of regions and the FP (S43).

Next, for the processing target region, the processor 81 performs a process of determining the presence or absence of an FP on the child’s face, display or non-display for a basic part, and a basic part when displayed, based on “Condition 1” to “Condition 4” described for the parents (S44). The determination method is based on the relationships among the conditions shown in the table of FIG. 14 above. In addition, the placement position is determined according to the placement position of the priority parent as described above. Moreover, for the front-back relationship between the FP and the basic parts, the settings of the priority parent are used.

Next, the processor 81 determines whether or not all regions have been processed (S45). If any unprocessed region remains (NO in S45), the processor 81 returns to S43 and repeats the processing. If all regions have been processed (YES in S45), next, for each part determined above, various parameters for the child’s face are adjusted as described above (S46).

Next, based on the determined and adjusted contents, the contents of the basic part data 333 and the FP data 337 for the child are set and stored (S47). Accordingly, a child’s face in which each part is placed based on the above contents is generated. Then, the child face part determination processing ends. Although not shown, in the processing related to the child‑birth event, after the child face part determination processing, determination of the body type of the child, setting of the human relationship data 342, etc., are performed, and these are stored as the individual resident data item 331 corresponding to the child.

This is the end of the detailed description of the game processing according to the exemplary embodiment.

As described above, in the exemplary embodiment, the user can generate a virtual resident, and, at this time, can generate a face using an FP as described above. Moreover, a child character can be generated based on characters serving as parents, and, at this time, a child’s face is generated in consideration of the FP and part‑display settings of the parents. Accordingly, it is possible to generate a new character corresponding to the part information of multiple characters on which the generation is based.

### Modifications

In the above embodiment, an example in which the parts are simply not placed has been given as an example of the non‑display setting for the basic parts. In this regard, in another exemplary embodiment, the non‑display setting may instead be implemented by providing a “transparency” parameter for the basic parts and treating the basic parts as being set to non‑display by setting the transparency to 100%.

In the above example, as an example of the FP, an FP in which a pattern or the like is hand-drawn on a transparent plate‑shaped object by the user is placed on the head object. In this regard, in another exemplary embodiment, the transparent plate‑shaped object may not necessarily be used, and the user may directly draw a pattern or the like onto the head object.

Furthermore, the FP has a content created by the user, but, for example, data of an FP created by the user may be able to be uploaded and downloaded. An FP created by another user may be able to be downloaded and used for a virtual resident created by the user.

In the above embodiment, objects each modeled after a human, “virtual residents”, have been given as an example; however, the above‑described processing may also be applied to objects other than humans, such as monsters. For example, the above‑described processing may be applied to a game in which monsters can be created, and a third monster (a child monster) is born from a first monster and a second monster corresponding to the parents. In this case, in addition to the head (face), the entire body may be used as a part placement area. In this case, for example, as the basic parts, parts prepared in advance for regions such as the face, hands, and legs may be selectable and placeable. As parts corresponding to the additional part (FP), additional parts hand‑drawn by the user as a face, hands, and legs may be placeable.

In the case of a game that uses monsters, the above‑described processing may be applied to a game in which not only a child monster is born but also a third monster is generated by combining a first monster and a second monster. The number of source monsters for combination may be three or more. In such a case, one of the monsters may be designated as the “priority monster” corresponding to the priority parent, and the above‑described processing may be applied.

Even in a game that uses characters each modeled after a human, the above‑described processing may be applied not only to the creation of child characters but also to a case in which a first character and a second character undergo an in‑game event such as “merging” or “fusion”, becoming a single entity, thereby creating a third character.

For example, the above processor may mean one or more processors in one apparatus such as a main body apparatus or may mean some or all of one or more processors included in each of multiple apparatuses such as a main body apparatus and a controller or a main body apparatus, a controller, and a server. The same applies to the memory of the information processing system and other components.

The program that causes a computer to execute each process may be a single program or may be a program group including a plurality of programs. In addition, the entirety of the program does not need to be stored in one apparatus. The program may mean, for example, the totality of programs that are stored in a plurality of apparatuses included in the information processing system, respectively.

In an information processing system including a terminal-side apparatus and a server-side apparatus capable of communicating via a network, at least part of the series of processes described above may be executed by the server-side apparatus. The server may be composed of a plurality of information processing apparatuses, and the processes may be executed by the plurality of information processing apparatuses in a shared manner.

While the exemplary embodiment and the modifications have been described, the description thereof is in all aspects illustrative and not restrictive. It is to be understood that various other modifications and variations may be made to the exemplary embodiment and the modifications.

What is claimed is:

1. One or more non-transitory computer-readable storage media having stored therein instructions for causing one or more processors to execute a game in which a game character having a plurality of types of character parts placed in a part placement area thereof is displayed, the instructions, when executed, causing the one or more processors to perform processing comprising:
in a first scene in which an appearance of the game character in the game is set,
in response to a character part editing instruction based on an operation input, changing an appearance parameter indicating an appearance in the game of each of the plurality of types of character parts of the game character,
in response to a display state editing instruction based on an operation input, setting each of the plurality of types of character parts of the game character to a display state in which the part is displayed in the game or a non-display state in which the part is hidden, and
in response to an additional part placement instruction based on an operation input, placing an additional part in the part placement area of the game character, the additional part being different from the plurality of types of character parts and generated in response to a part generation instruction performed by a user; and
in a second scene in which a third game character is generated based on a first game character and a second game character in the game,
if a first type of character part among the plurality of types of character parts of the first game character is set to the display state, setting the appearance parameter of the first type of character part of the third game character in accordance with the appearance parameter of the first type of character part of at least one of the first game character and the second game character,
if the first type of character part among the plurality of types of character parts of the first game character is set to the non-display state, setting the first type of character part of the third game character to the non-display state, and
further placing an additional part based on the additional part placed in the part placement area of the first game character, in the part placement area of the third game character.

2. The one or more non-transitory computer-readable storage media according to claim 1, wherein the processing further comprises, in the first scene, generating the additional part in response to an additional part generation instruction based on an operation input.

3. The one or more non-transitory computer-readable storage media according to claim 2, wherein, in response to the additional part generation instruction, at least one of a pattern, a shape, a color, and a size of the additional part is set.

4. The one or more non-transitory computer-readable storage media according to claim 1, wherein the processing further comprises, in the second scene, not placing the additional part in the part placement area of the third game character if the additional part is not placed in the part placement area of the first game character.

5. The one or more non-transitory computer-readable storage media according to claim 4, wherein the processing further comprises, in the second scene, if all of the plurality of types of character parts of the first game character are in the non-display state, the additional part is not placed therein, and the additional part is placed in the second game character,
placing an additional part based on the additional part placed in the part placement area of the second game character, in the part placement area of the third game character.

6. The one or more non-transitory computer-readable storage media according to claim 1, wherein the processing further comprises, in the second scene, if the first type of character part of the first game character is in the non-display state, the additional part is not placed therein, and the first type of character part of the second game character is in the display state,
setting the appearance parameter of the first type of character part of the third game character in accordance with the appearance parameter of the first type of character part of the second game character.

7. The one or more non-transitory computer-readable storage media according to claim 1, wherein
the appearance parameter includes at least a placement position parameter indicating a position at which the character part is placed with respect to the part placement area, and
the processing further comprises, in the second scene, if the first type of character part of the first game character is set to the display state, setting the placement position parameter of the first type of character part of the third game character in accordance with the placement position parameter of the first type of character part of the first game character.

8. The one or more non-transitory computer-readable storage media according to claim 1, wherein the processing further comprises, in the first scene, in response to the additional part placement instruction, placing the additional part on a front side located in front of the character parts or on a back side located behind the character parts.

9. The one or more non-transitory computer-readable storage media according to claim 8, wherein the further comprises, in the second scene:
if the additional part of the first game character is placed on the front side, placing the additional part of the third game character on the front side; and
if the additional part of the first game character is placed on the back side, placing the additional part of the third game character on the back side.

10. A game system for executing a game in which a game character having a plurality of types of character parts placed in a part placement area thereof is displayed, the game system comprising
one or more processors, and
one or more non-transitory computer-readable storage media having stored therein instructions that, when executed, cause the one or more processors to perform processing comprising:
in a first scene in which an appearance of the game character in the game is set,
in response to a character part editing instruction based on an operation input, changing an appearance parameter indicating an appearance in the game of each of the plurality of types of character parts of the game character,
in response to a display state editing instruction based on an operation input, setting each of the plurality of types of character parts of the game character to a display state in which the part is displayed in the game or a non-display state in which the part is hidden, and
in response to an additional part placement instruction based on an operation input, placing an additional part in the part placement area of the game character, the additional part being different from the plurality of types of character parts and generated in response to a part generation instruction performed by a user; and
in a second scene in which a third game character is generated based on a first game character and a second game character in the game,
if a first type of character part among the plurality of types of character parts of the first game character is set to the display state, setting the appearance parameter of the first type of character part of the third game character in accordance with the appearance parameter of the first type of character part of at least one of the first game character and the second game character,
if the first type of character part among the plurality of types of character parts of the first game character is set to the non-display state, setting the first type of character part of the third game character to the non-display state, and
further placing an additional part based on the additional part placed in the part placement area of the first game character, in the part placement area of the third game character.

11. A game apparatus for executing a game in which a game character having a plurality of types of character parts placed in a part placement area thereof is displayed, the game apparatus comprising
one or more processors, and
one or more non-transitory computer-readable storage media having stored therein instructions that, when executed, cause the one or more processors to perform processing comprising:
in a first scene in which an appearance of the game character in the game is set,
in response to a character part editing instruction based on an operation input, changing an appearance parameter indicating an appearance in the game of each of the plurality of types of character parts of the game character,
in response to a display state editing instruction based on an operation input, setting each of the plurality of types of character parts of the game character to a display state in which the part is displayed in the game or a non-display state in which the part is hidden, and
in response to an additional part placement instruction based on an operation input, placing an additional part in the part placement area of the game character, the additional part being different from the plurality of types of character parts and generated in response to a part generation instruction performed by a user; and
in a second scene in which a third game character is generated based on a first game character and a second game character in the game,
if a first type of character part among the plurality of types of character parts of the first game character is set to the display state, setting the appearance parameter of the first type of character part of the third game character in accordance with the appearance parameter of the first type of character part of at least one of the first game character and the second game character,
if the first type of character part among the plurality of types of character parts of the first game character is set to the non-display state, setting the first type of character part of the third game character to the non-display state, and
further placing an additional part based on the additional part placed in the part placement area of the first game character, in the part placement area of the third game character.

12. A computer-implemented method comprising:
executing a game in which a game character having a plurality of types of character parts placed in a part placement area thereof is displayed;
in a first scene in which an appearance of the game character in the game is set,
in response to a character part editing instruction based on an operation input, changing an appearance parameter indicating an appearance in the game of each of the plurality of types of character parts of the game character,
in response to a display state editing instruction based on an operation input, setting each of the plurality of types of character parts of the game character to a display state in which the part is displayed in the game or a non-display state in which the part is hidden, and
in response to an additional part placement instruction based on an operation input, placing an additional part in the part placement area of the game character, the additional part being different from the plurality of types of character parts and generated in response to a part generation instruction performed by a user; and
in a second scene in which a third game character is generated based on a first game character and a second game character in the game,
if a first type of character part among the plurality of types of character parts of the first game character is set to the display state, setting the appearance parameter of the first type of character part of the third game character in accordance with the appearance parameter of the first type of character part of at least one of the first game character and the second game character,
if the first type of character part among the plurality of types of character parts of the first game character is set to the non-display state, setting the first type of character part of the third game character to the non-display state, and
further placing an additional part based on the additional part placed in the part placement area of the first game character, in the part placement area of the third game character.
